(19) United States
(12) Patent Application Publication
(10) Pub. No.: US 2008/0065684 A1
(43) Pub. Date: Mar. 13, 2008

(54) METHOD AND A SYSTEM FOR ANALYZING PLAYS OF SPORTS TEAMS

(76) Inventor: Avraham ZILBERMAN, Jerusalem (IL)

Correspondence Address: LADAS & PARRY, 5670 WILSHIRE BOULEVARD, SUITE 2100, LOS ANGELES, CA, 90036-5679, US

(21) Appl. No.: 11/851,080

(22) Filed: Sep. 6, 2007

(30) Foreign Application Priority Data
Sep. 10, 2006 (IL) 177978

(51) Int. Cl. G06F 7/00

(52) U.S. Cl. 707/102; 273/317.1

(57) ABSTRACT

There is provided a multi-player sports teams ball games analysis method, including entering into a computer data concerning a team players' identity, displaying a portion of two specific games of the team, entering data concerning ball passing between individual players during the games, storing the data, entering data regarding the ball game outcome of each of the games and storing the data, processing the data entered and stored for establishing a play pattern which is repeated for the majority of plays in each game, and displaying the patterns and outcomes of the ball games for establishing correlation between a ball game pattern and the outcome of the game of the team. A system for analyzing a multi-player sports teams ball game, is also included.

### FIELD OF THE INVENTION

The present invention relates to the field of sports, and more particularly to the field of multi-player sports teams' ball games. Specifically, the present invention is concerned with a method and a system for analyzing the play patterns of sport teams in specific games.

### BACKGROUND OF THE INVENTION

The term “multi-player ball game” is used herein to designate such games as basketball, football, handball, volleyball and the like. All of these ball games have in common the feature of passing the ball from one player to another before scoring, whereafter the ball is transferred to the other team, whose players function in the same manner. Furthermore, these games are also characterized by the outcome, wherein the team that scores the maximum number of points is regarded as the winner, while the other team is the loser, and wherein if each team scores the same number of points, the outcome is regarded as a tie or a draw.

As is further known, prior to playing a rival team, each team prepares itself for the game with a view to win the game, by “studying” the other team. This process is carried out in accordance with the different coaches understanding of the game and various, sometimes prejudiced, concepts concerning the other team. In general, it can be seen that while it is a common practice to prepare a team for the next game, it is usually done by watching video clips of part of the other teams' games while the coach comments on isolated plays and other moves of the other team, moves of individual players and performances of players. This routine is cumbersome and time consuming, and even more so, does not necessarily focus on major issues, which as a whole, characterize the other teams' play, resulting in their win.

### DISCLOSURE OF THE INVENTION

It is therefore a broad object of the present invention to provide a method and system for analysing a sports teams' manner of carrying out plays of specific games.

It is a further object of the present invention to provide a method and a system for analysing play patterns of a team in specific games.

It is still a further object of the present invention to provide a method and a system for analysing play patterns of several games of a team and for correlating the play patterns with the game's outcome, namely, win, draw or lose.

It is yet a further object of the present invention to provide a method and a system for analysing individual player's play intensity in a specific game.

The term “play intensity” is intended to designate an indication of the involvement of a player in the game by the number of times the player received and passed the ball to another player, performed tackles or blocking, and scored, as well as the player's overall movement over the field during a game.

In accordance with the present invention there is provided a multi-player sports teams ball games analysis method, comprising entering into a computer data concerning a team players' identity, displaying at least a portion of at least two specific games of said team, entering data concerning ball passing between individual players during said games, storing said data, entering data regarding the ball game outcome of each of the games and storing the data, processing the data entered and stored for establishing a play pattern which is repeated for the majority of plays in each game, and displaying the patterns and outcomes of the ball games for establishing correlation between a ball game pattern and the outcome of the game of said team.

The invention further provides a system for analysing a system for analyzing a multi-player sports teams ball game, comprising a recorded ball game display facility, a unit for entering into a computer, data regarding the passing of the ball between players and the outcome of the games, and a processor for processing the passing of the ball between individual players to display at least one play pattern which is repeated for the majority of plays in each game and correlating between the play patterns and the outcome of the games.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purpose of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a block diagram of an embodiment of a system for analysing play patterns of sports teams;

FIGS. 2a, 2b and 2c are block diagrams illustrating three embodiments for entering data into the system of FIG. 1;

FIG. 3 is a block diagram illustrating correlation between play patterns and game results;

FIGS. 4a and 4b are graphic illustrations of two play patterns as correlated with game results;

FIG. 4c is a display in the form of a table providing play patterns and intensities, and

FIG. 5 is a schematic illustration of a basketball court divided into playing zones.

### DETAILED DESCRIPTION OF THE PREFERRED EMBODIMENTS

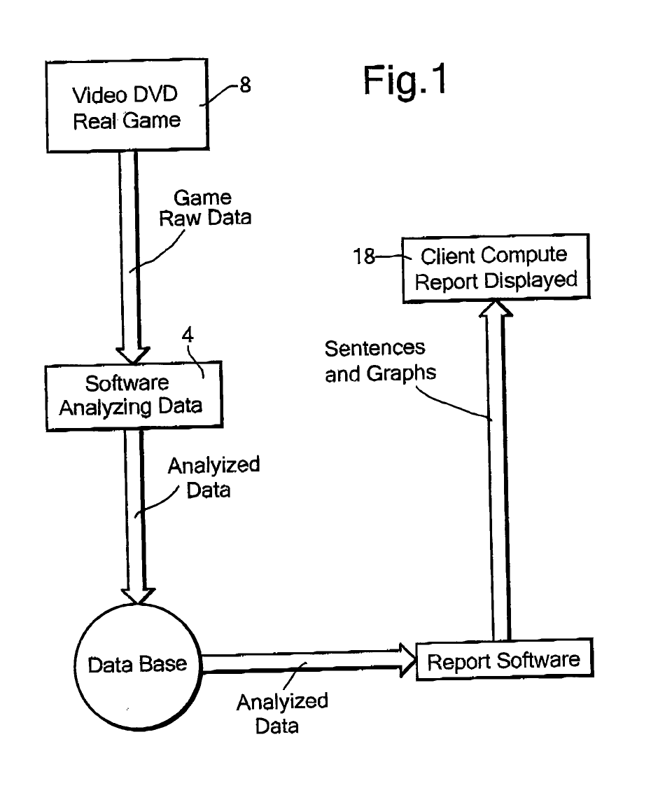

The system and method for analysing the play patterns of a sports team in specific games and the correlation of the patterns with the outcome of the games, namely, win, draw or lose, are shown in FIGS. 1 to 3. Ball games, as hereinbefore described, are commonly recorded and video cassettes or DVD's of the games are readily available to interested parties. Hence, professional teams regularly acquire the entire, or only parts of games of certain teams, especially those against whom the team is scheduled to play during the season. Alternatively, if a game or a series of games are shown on television, the interested party may subscribe for a reproduction of the recorded video from whoever holds the rights thereto.

Hence, in preparation for a game to be played against a rival team, video, DVD or the like recording of the games of the rival team is displayed on a facility 2, as seen in FIG. 1. The operator on behalf of the interested party, whether a professional or expert in a particular ball game, say for clarity sake, a coach's assistant of a basketball team, or merely any other non-professional person, while viewing the game, will enter into a computer or processor 4, data concerning players' codes, e.g., the player's number, visually, clearly exhibited on their shirt, identifying all the players of the team of interest, as well as other data or information, such as their major formal task in the team, namely, Guard (G), Forward (F), Small Forward (SF), Point Forward (PF), Center (C), etc. As the display of the game progresses, the operator enters data with regard to the passing of the ball from one player to the other, and conversely the reception of the ball by each player, until the score is achieved, or the ball is transferred to the other team.

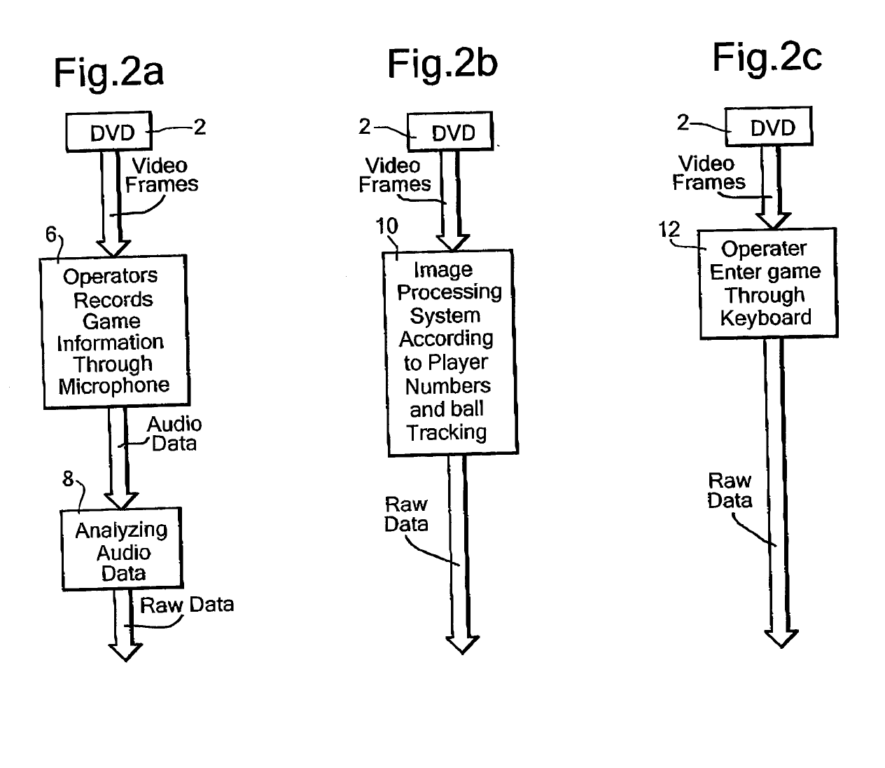

The different ways in which the operator can enter this information and data into the processor 4, are illustrated in FIGS. 2a to 2c. As seen in FIG. 2a, displayed video frames from the DVD are converted into audio data by the operator, namely, the operator audially records the viewed moves of the plays by means of a microphone, at 6, and the audio data, by audio-to-data converter 8 is entered into a processor 4. In FIG. 2b, the video frames are automatically processed by means of an image tracking unit 10 by reading the players' numbers and by tracking the passing of the ball from one player to another.

The third manner of entering the data and information into the system's processor illustrated in FIG. 2c, is by means of a keyboard 12, through which the passage of the ball from one player bearing a certain number to another player bearing a different number, as viewed by the operator, is easily entered into the processor 4.

At the end of the game, the operator also enters into the processor the game result which may be effected by entering the number of points the team scored, in addition to indicia designating win, draw or lose.

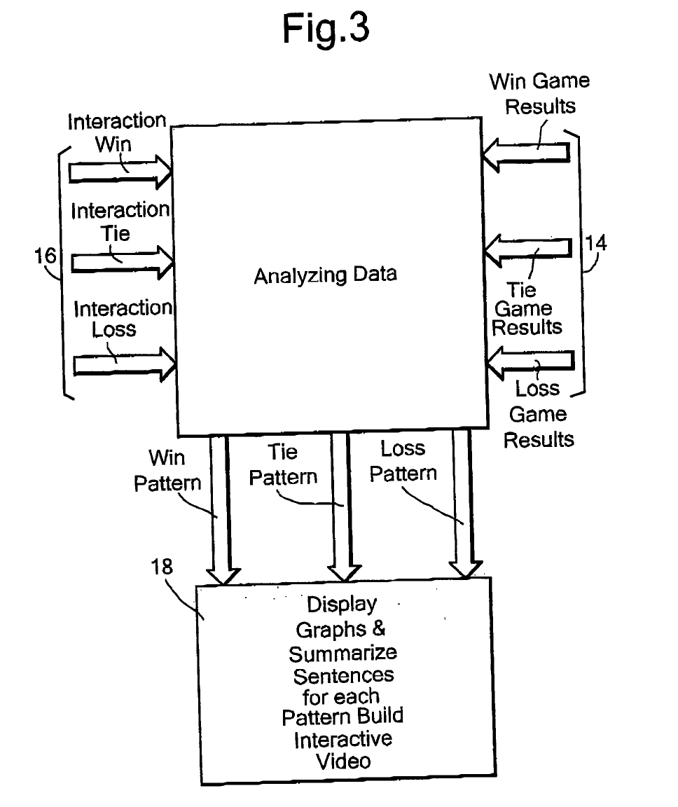

Once the raw data with regard to the ball passings between players and the game result is entered by any of the above-described methods or a combination thereof, the processor 4 can provide an output consisting of a written report, e.g., in the form of a table or tables setting forth the passing of the ball or interaction between players, namely, the number of times the ball was passed from a certain player to another specific player and the sequence of ball passing and receipt from one player to another, as well as the game's result, as shown in 14 and 16 of FIG. 3.

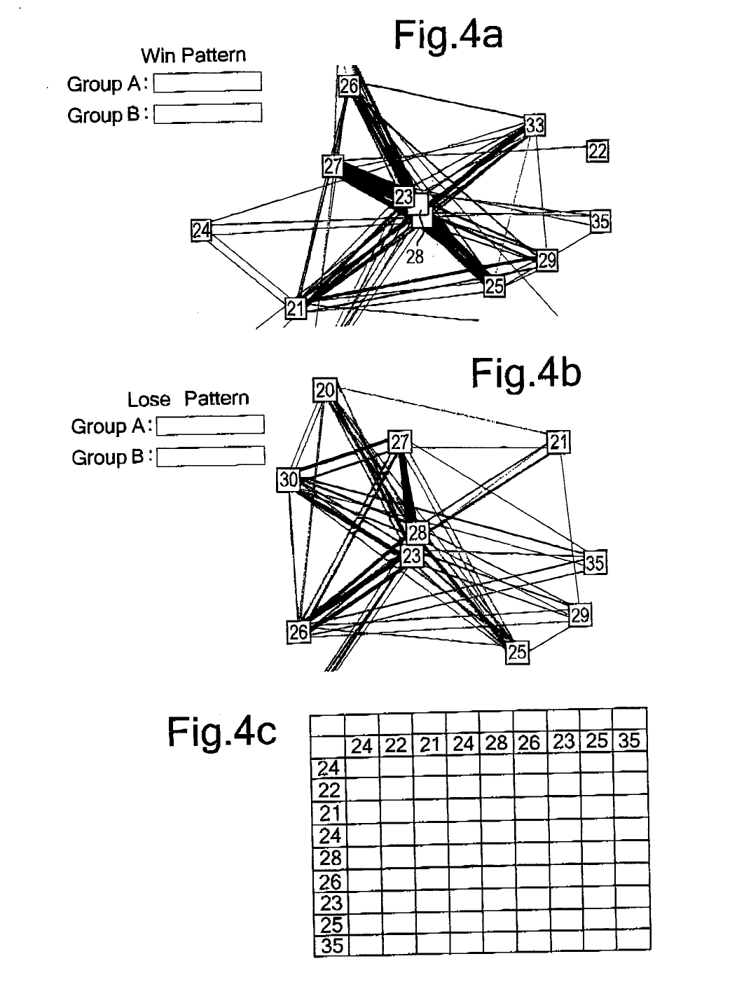

A preferred manner of an output is, however, a graphical display 18, as shown in FIG. 3 and FIGS. 4a and 4b, which may, of course, be accompanied by tables and/or footnotes, etc., as seen in FIG. 4c. Clearly seen in FIGS. 4a and 4b are two game patterns: a win pattern illustrated by FIG. 4a, and a different ball-passing pattern illustrated in FIG. 4b, which resulted in a loss. An indication of the number of points each team scored is provided adjacent to the notation Group “A”, Group “B”.

The lines interconnecting the same two players may advantageously be displayed in the same color, for better visual comprehension.

FIG. 4c provides a table summing up the number of times each player passed the ball to each of the other players, enabling the classification of pairs of players interacting at levels designated “high intensity”, “medium intensity” and “low intensity”, thereby supplementing the game pattern pictures with information regarding the relative intensity of involvement in the game of each player and pair of players. This will complete the analysis of the game patterns and individual player's involvement for specific win, lose and draw games.

Players intensity data can also include the intensity of movement on the field during each quarter or half of a game, the number of times a player performs a block, facilitating another player's smooth movement.

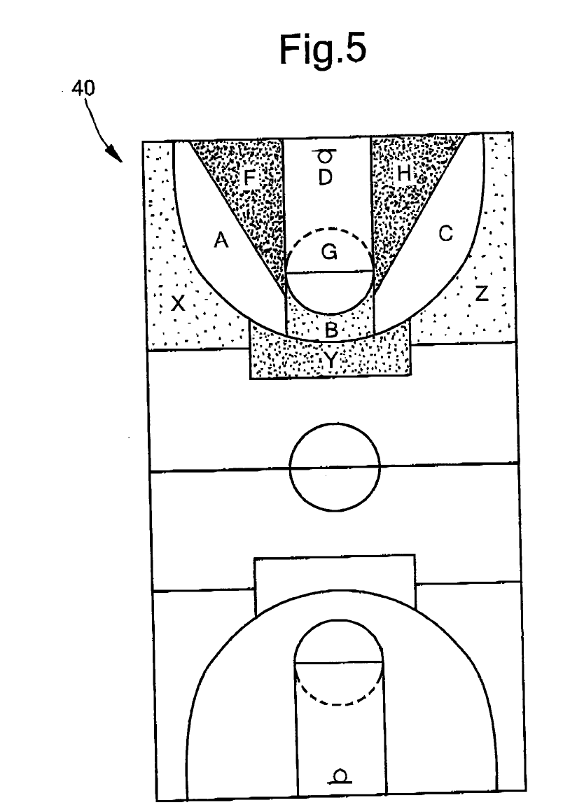

FIG. 5 illustrates an example of a ball game court, e.g., a basketball court or field 20, divided into say, ten relevant play zones, designated by an indicia such as A, B, C, D, F, G, H, X, Y and Z. For the same or a different ball game and field, the field area is divided differently. The division of the field area into zones, enables the analysis not only of ball passage from one player to another until the team scores or loses the ball, but also the analysis of individual players' locations on the field when passing and receiving the ball, as well as the players' movements about the field without a ball, which is not less important.

Thus, upon entering into a computer data concerning a team's pattern of ball passing between individual players, this data can also now be accompanied by information regarding the players' locations on the field when passing and receiving the ball. The designation of players and their respective locations in a zone will be e.g., the player No. 5 and the player's instant location, say in zone X, thus there will be entered 5X. If the player 5 in zone X passes the ball to a player 8 in zone C, then there will be entered e.g., 5X→8C, etc. This added information, with or without information concerning the other players' movements along the field, provides a more complete play pattern of a specific team.

The division of a field into zones can easily be effected by superposing a zone allocation pattern on the display screen.

When a skilled person enters into the computer data concerning a particular game, as seen on a video display screen for analysis of a game, the skilled person may, after awhile, detect certain play patterns and merely enter a code of a game pattern into the computer, without having to enter a multiplicity of data items regarding the ball passage from one player to the other, until the team scores or misses and the ball is transferred to the other team.

The inclusion of a player's location on the field, with or without a ball, when analyzing play patterns, provides a much clearer comprehension of certain game patterns, thereby enabling the analyzer to more easily spot and enter a play pattern not requiring the tedious time consuming entry of each and every move of all players, but only the code of a certain play pattern, or a variation thereof.

This tool also enables the analysis, not only of a rival team, but also of ones own team. Furthermore, in addition to the analysis of statistical data concerning true events and facts which took place during a game, namely, true play patterns and scores, there can be conducted a players' debriefing in which players provide their comprehension, feelings and understanding of a game, specifically with regard to planned play patterns and the manner in which it was actually carried out, including their own actual participation. This type of input can also be analyzed in comparison with the factual analysis data for drawing suitable conclusions with respect to players' feelings and states of mind.

Obviously, the more games analyzed, the more unequivocal the correlation between the game pattern and the outcome of the games, i.e., win pattern, tie pattern and loss pattern, and in any event, even a loss result of a strong team playing a certain pattern may provide important information when preparing for the match.

Hence, once a win pattern of a rival team is analyzed and known, it is much easier to prepare to play against the team by trying to prevent the rival time from playing their winning pattern.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A multi-player sports teams ball games analysis method, comprising:
entering into a computer data concerning a team players' identity;
displaying at least a portion of at least two specific games of said team;
entering data concerning ball passing between individual players during said games;
storing said data;
entering data regarding the ball game outcome of each of the games and storing the data;
processing the data entered and stored for establishing a play pattern which is repeated for the majority of plays in each game, and
displaying the patterns and outcomes of the ball games for establishing correlation between a ball game pattern and the outcome of the game of said team.

2. The method as claimed in claim 1, wherein the player's identity is provided by the number depicted on the player's outfit.

3. The method as claimed in claim 1, wherein the ball game outcome is selected from the group of games won, lost or drawn.

4. The method as claimed in claim 1, wherein the ball game pattern is graphically displayed by depicting a line between two players designating the passing of the ball between players.

5. The method as claimed in claim 4, wherein the ball game pattern is graphically displayed by depicting the positions of the players on the field relative to the field boundaries.

6. The method as claimed in claim 4, wherein said lines interconnecting same two players are of the same color.

7. The method as claimed in claim 4, wherein the ball game pattern is graphically displayed by way of a table indicating the number of times the ball passes between two players.

8. The method as claimed in claim 1, wherein said data is entered into a computer audially.

9. The method as claimed in claim 1, wherein said data is entered into a computer through imaging of players' numbers and the tracking of the ball between players.

10. The method as claimed in claim 1, wherein said data is entered into a computer by means of a keyboard.

11. The method as claimed in claim 1, further comprising dividing the field on which the ball game is played into zones.

12. The method as claimed in claim 11, wherein said zones are designated by an indicia.

13. The method as claimed in claim 12, wherein said zones are graphically displayed to be superposed on the display of a game.

14. The method as claimed in claim 13, wherein data concerning ball passing between an individual player also includes data concerning the player's position on the field.

15. The method as claimed in claim 11, further comprising entering data concerning players' movements from zone to zone.

16. A system for analyzing a multi-player sports teams ball game, comprising:
a recorded ball game display facility;
a unit for entering into a computer, data regarding the passing of the ball between players and the outcome of the games, and
a processor for processing the passing of the ball between individual players to display at least one play pattern which is repeated for the majority of plays in each game and correlating between the play patterns and the outcome of the games.

17. The system as claimed in claim 16, wherein said data is entered into a computer by means of a microphone and an audio-to-data converter.

18. The system as claimed in claim 16, comprising an image tracking unit for entering data into said computer.

19. The system as claimed in claim 16, wherein said unit for entering data into a computer comprises a keyboard.

20. The system as claimed in claim 16, further comprising a display for graphically displaying patterns of plays showing the passing of the ball from one player to another.

21. The system as claimed in claim 20, wherein the passing of the ball between same two players is displayed by the same color.

22. The system as claimed in claim 16, further comprising a display for graphically displaying at least a pattern of a field on which the game is played, as divided into zones.

23. The system as claimed in claim 22, wherein the data also includes designation of location of players on the field according to zones.
